(19) United States
(12) Patent Application Publication
(10) Pub. No.: US 2015/0156418 A1
(43) Pub. Date: Jun. 4, 2015

(54) OFFSET CORRECTION SYSTEM AND METHOD FOR CONTROLLING THE SAME

(71) Applicant: SAMSUNG ELECTRO-MECHANICS CO., LTD., Gyeonggi-Do (KR)

(72) Inventor: Yo Sub MOON, Gyeonggi-Do (KR)

(73) Assignee: SAMSUNG ELECTRO-MECHANICS CO., LTD., Gyeonggi-Do (KR)

(21) Appl. No.: 14/251,171

(22) Filed: Apr. 11, 2014

(30) Foreign Application Priority Data
Dec. 2, 2013 (KR) 10-2013-0148631

(51) Int. Cl. H04N 5/232

(52) U.S. Cl. CPC H04N 5/23287

(57) ABSTRACT

Embodiments of the invention provide a mold for forming a lens including a first core coupled with a first core hole of a first mold, and a second core coupled with a second core hole of a second mold to face the first core. In accordance with at least one embodiment, the first core and the second core are made of a material having a coefficient of thermal expansion larger than that of the first mold and the second mold, and outer diameters of the first core and the second core are each formed to be smaller than diameters of the first core hole and the second core hole.

### CROSS REFERENCE TO RELATED APPLICATION

This application claims the benefit of and priority under 35 U.S.C. §119 to Korean Patent Application No. KR 10-2013-0148631, entitled “System for Correcting Off-Set and Controlling Method Thereof,” filed on Dec. 2, 2013, which is hereby incorporated by reference in its entirety into this application.

### BACKGROUND

1. Field of the Invention

The present invention relates to an offset correction system and a method for controlling the same.

2. Description of the Related Art

A digital photographing apparatus may process a received image via a digital signal processor via an imaging device, compress the image to generate an image file, and store the image file in a memory.

Although the digital photographing apparatus may display and show the image of the image file, which is received via the imaging device or stored in a storage medium, on a display device such as a liquid crystal display (LCD), the digital photographing apparatus such as a camera may shake due to user handshake, while a user captures a desired image. Accordingly, due to shake, an image input via an imaging device may shake, resulting in photography failure.

Accordingly, in order to prevent photography failure due to handshake, when handshake occurs, a correcting process, as described, for example, in KR 2012-0073136, is performed via a handshake correction function (optical image stabilization: OIS) of detecting an angular velocity of a camera via a gyro sensor installed in a camera, calculating a driving distance of a camera lens based on the angular velocity, moving the lens by as much as the distance via a voice coil motor (VCM), and then, feeding back a location of the lens from an output signal of a hall sensor.

However, a frequency of the signal output from the hall sensor is 1 Hz to 30 Hz and belongs to a low frequency band, and the size of the output signal is small. Thus, it is necessary to amplify the output signal through an amplifier. In this regard, when direct current (DC) offset occurs in the output signal, accuracy of a handshake correction function based on the output signal may be degraded due to deterioration of the hall sensor.

### SUMMARY

Accordingly, embodiments of the present invention provide an offset correction system and a method for controlling the same, which applies an offset correction voltage to an internal terminal of an operational amplifier (OP-AMP) for amplifying a signal detected by a hall sensor with predetermined gain, when direct current (DC) offset occurs in the detected signal, thereby minimizing possibility of change in an output signal of the OP-AMP due to noise generated in the offset correction voltage.

According to an embodiment of the present invention, there is provided an offset correction system including a location sensor for outputting a signal about location information of a lens, a digital signal processor for determining whether direct current (DC) offset occurs from the output signal and generating a digital control signal for correction of the DC offset when the DC offset occurs, and an amplifier for amplifying the signal output by the location sensor via an operational amplifier (OP-AMP) and applying an offset correction voltage corresponding to the digital control signal directly to an internal terminal of the OP-AMP when the DC offset occurs.

In accordance with at least one embodiment, the location sensor includes a hall sensor for outputting a first voltage signal V₁ and a second voltage signal V₂, corresponding to a location of the lens.

In accordance with at least one embodiment, the OP-AMP includes at least one P-channel metal oxide semiconductor (PMOS) and N-channel metal oxide semiconductor (NMOS).

In accordance with at least one embodiment, the internal terminal of the OP-AMP is a bulk terminal of the at least one PMOS, and the PMOS has a gate terminal that is electrically connected to a non-inverting terminal or inverting terminal of the OP-AMP.

In accordance with at least one embodiment, the PMOS has a threshold voltage that varies according to the offset correction voltage input to the bulk terminal of the PMOS.

In accordance with at least one embodiment, the PMOS also has drain current that varies according to the threshold voltage of the PMOS.

In accordance with at least one embodiment, the NMOS has a bulk terminal that is electrically connected to a ground terminal.

In accordance with at least one embodiment, the digital signal processor generates the digital control signal corresponding to the offset correction voltage for correction of the DC offset, when the DC offset occurs between the first voltage signal V₁ and the second voltage signal V₂.

In accordance with at least one embodiment, the offset correction system further includes a second signal converter for converting the digital control signal into an offset correction voltage in an analog form and applying the offset correction voltage to the amplifier.

In accordance with at least one embodiment, the offset correction system further includes a first signal converter for converting the signal output from the amplifier in a digital signal form.

In accordance with at least one embodiment, the amplifier includes an OP-AMP having an internal terminal to which the offset correction voltage is directly applied, a first resistor electrically connected to each of a non-inverting terminal and an inverting terminal of the OP-AMP, and a second resistor for electrically connecting the inverting terminal and an output terminal of the OP-AMP.

In accordance with at least one embodiment, the OP-AMP includes a second PMOS having a gate terminal that is electrically connected to the inverting terminal and a third PMOS having a gate terminal that is electrically connected to the non-inverting terminal.

In accordance with at least one embodiment, the offset correction voltage is applied directly to a bulk terminal of the second PMOS and third PMOS.

In accordance with at least one embodiment, the OP-AMP includes a first PMOS for controlling input current I_{D} using a bias voltage input to a gate terminal, an offset correction circuit to which the offset correction voltage is applied, a current mirror module for equalizing amounts of currents I_{D1} and I_{D2} output from the offset correction module, a fourth PMOS for controlling output current I_{P} using a bias voltage input to a gate terminal, and a third NMOS for amplifying the output current I_{P} with predetermined gain to generate an output voltage V_{O}.

In accordance with at least one embodiment, the offset correction circuit includes a second PMOS having a gate terminal electrically connected to the inverting terminal of the OP-AMP and a third PMOS having a gate terminal electrically connected to the non-inverting terminal.

In accordance with at least one embodiment, the offset correction circuit applies the offset correction voltage directly to a bulk terminal of the second PMOS and third PMOS.

According to another embodiment of the present invention, there is provided a method for controlling an offset correction system, the method including detecting a signal about location information of a lens, amplifying the detected signal via an operational amplifier (OP-AMP), determining whether direct current (DC) offset occurs from the detected signal, and correcting offset by generating an offset correction voltage and applying the offset correction voltage to an internal terminal of the OP-AMP, when the DC offset occurs.

In accordance with at least one embodiment, the correcting step includes generating a digital control signal for correction of the DC offset, when the DC offset occurs, converting the digital control signal into the offset correction voltage, corresponding to the digital control signal, in an analog form, and applying the offset correction voltage to an internal terminal of the OP-AMP.

In accordance with at least one embodiment, the internal terminal of the OP-AMP is a bulk terminal of the at least one PMOS, and the PMOS has a gate terminal that is electrically connected to a non-inverting terminal or inverting terminal of the OP-AMP.

In accordance with at least one embodiment, the method further includes the step of converting the amplified signal in a digital signal form after the amplifying step.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a block diagram illustrating an offset correction system, in accordance with an embodiment of the present invention.

FIG. 2 is a flowchart illustrating a method for controlling an offset correction, in accordance with an embodiment of the present invention.

FIG. 3 is a circuit diagram illustrating an amplifier of an offset correction system, in accordance with an embodiment of the present invention.

FIG. 4 is a diagram illustrating an equivalent circuit diagram of an operational amplifier (OP-AMP) of an amplifier, in accordance with an embodiment of the present invention.

FIG. 5 is a diagram illustrating the structure of a PMOS and an NMOS included in an OP-AMP of an amplifier, in accordance with an embodiment of the present invention.

FIGS. 6(a)-(c) illustrate influence of an output voltage of an OP-AMP from an offset correction voltage, in accordance with embodiments of the present invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, preferred embodiments of the present invention will be described in detail with reference to the attached drawings. Hereinafter, driving of a lens will be described based on one axis (X-axis or Y axis) of the lens, which may be applied to another axis (X-axis or Y axis) in the same way. In addition, a P-channel metal oxide semiconductor (PMOS) and an N-channel metal oxide semiconductor (NMOS) refer to P-type and N-type metal-oxide semiconductor field effect transistor (MOSFET) transistors, respectively.

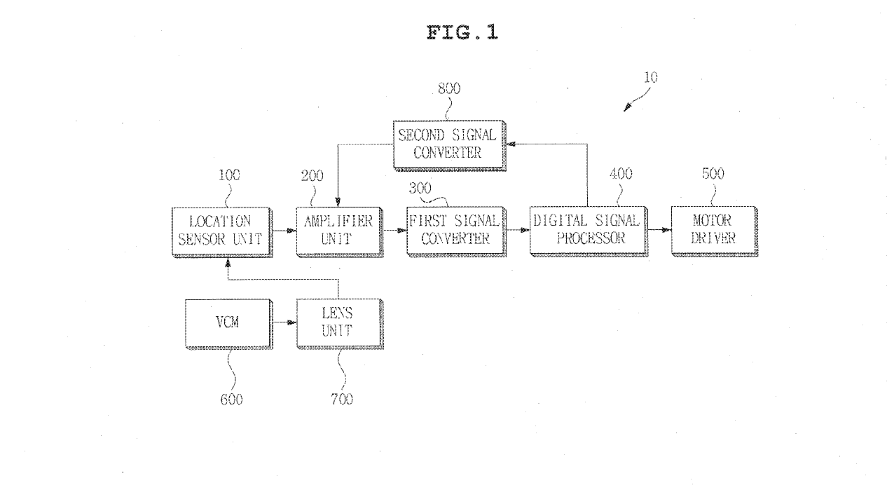

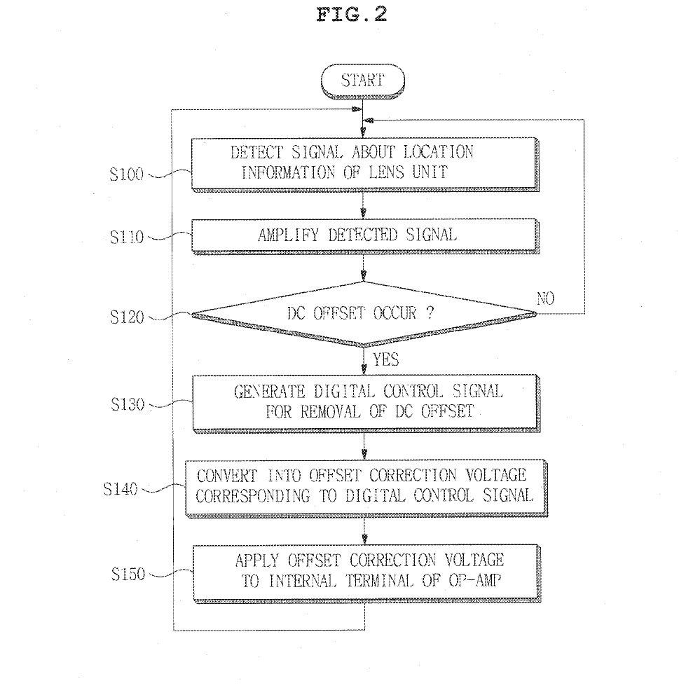

FIG. 1 is a block diagram illustrating an offset correction system, in accordance with an embodiment of the present invention. FIG. 2 is a flowchart illustrating a method for controlling an offset correction, in accordance with an embodiment of the present invention. In accordance with at least one embodiment, as shown in FIGS. 1 and 2, the offset correction system 10 includes a location sensor 100, an amplifier 200, a first signal converter 300, a digital signal processor 400, a second signal converter 800, a motor driver 500, a voice coil motor (VCM) 600, and a lens 700.

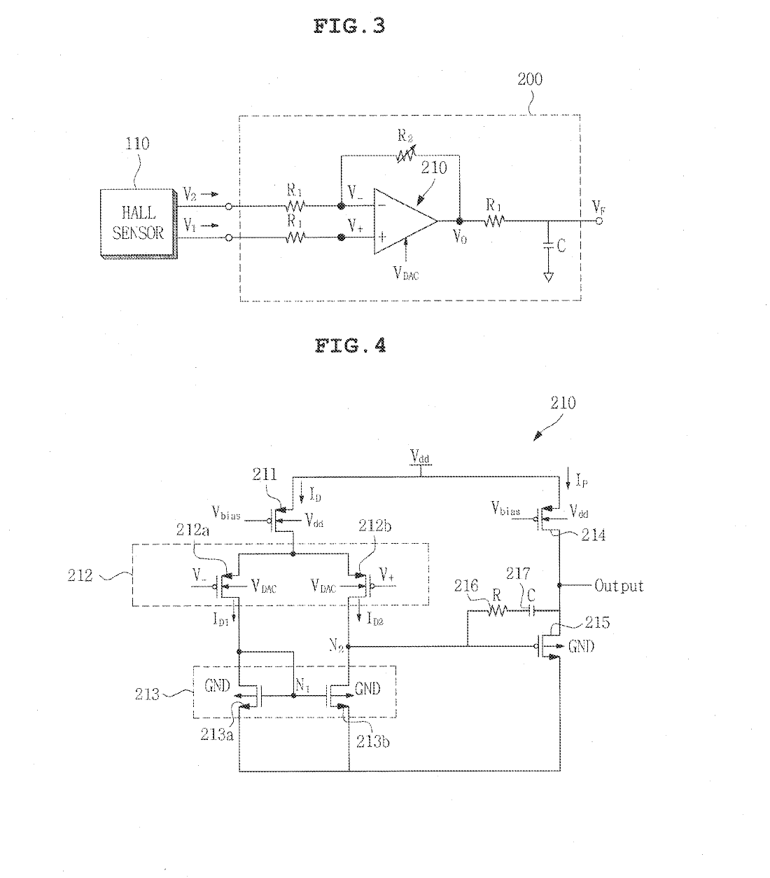

In accordance with at least one embodiment, the location sensor 100 includes a hall sensor 110 (refer to FIG. 3) for detection of a current location of the lens 700 using a hall effect, whereby a voltage varies according to intensity of a magnetic field, and an angular velocity sensor (not shown) for detection of an angular velocity of movement due to a handshake of a photographer, and detects location information of the lens 700 using the hall sensor 110 and the angular velocity sensor (not shown) (S100). Here, the hall sensor 100 outputs a first voltage signal V₁ and a second voltage signal V₂, which correspond to the location of the lens 700 (S100). Here, the first voltage signal V₁ and the second voltage signal V₂ may have, but are not limited to, a sine wave form.

As further shown in FIGS. 1 and 2, the amplifier 200, according to at least one embodiment, includes an operational amplifier (OP-AMP) 210 (refer to FIG. 3) and amplifies voltage signals V₁ and V₂ corresponding to a current location of the lens 700, detected by the hall sensor 110, via the OP-AMP 210 (S110). In accordance with one embodiment, the amplifier 200 is a low noise amplifier (LNA). The first signal converter 300 converts the amplified voltage value into a digital value and is, for example, an analog digital converter.

In addition, with regard to the amplifier 200, when DC offset between the first and second voltage signals V₁ and V₂ occurs, an offset correction voltage V_{DAC} for correction of the DC offset is applied directly to an internal terminal of the OP-AMP 210, which will be described in more detail.

In accordance with at least one embodiment, the digital signal processor 400 generates a digital control signal for control of a driving range of the lens 700 based on the location information of the lens 700, detected from the location sensor 100. The digital control signal is, for example, composed of 10 bits. Among the 10 bits, a most significant bit (MSB) is a sign bit and refers to a driving direction of the lens 700, and the remaining bits refer to the amount of driving current of the VCM 600, corresponding to a moving distance of the lens 700.

In addition, the motor driver 500 generates a driving voltage of the VCM 600, for driving the lens 700, based on the digital control signal input from the first signal converter 300, and drives the VCM 600 using the driving voltage. Here, the digital signal processor 400 generates the digital control signal via proportion integral derivative (PID) control.

In addition, the digital signal processor 400 determines whether DC offset occurs between the first and second voltage signals V₁ and V₂ output from the hall sensor 110 (S120) and generates a digital control signal for correction of the DC offset, when the DC offset occurs (S130). The second signal converter 800 converts the digital control signal into an offset correction voltage VDAC in an analog form (S140) and applies the offset correction voltage VDAC to an internal terminal of the amplifier 200 (S150).

As described above, according to embodiments of the present invention, an offset correction system determines whether DC offset occurs in an output signal of a hall sensor, generates a digital control signal for correction of the DC offset, when the DC offset occurs, applying an offset correction voltage corresponding to the digital control signal directly to an internal terminal of an OP-AMP, and correct the DC offset in real time, thereby more stably obtaining accuracy for correction of image shake due to the handshake of a photographer based on location information detected from the hall sensor while the lens is driven.

Hereinafter, with reference to FIGS. 3 to 5, correction of DC offset by applying an offset correction voltage to an amplifier of an offset correction system according to an embodiment of the present invention will be described in more detail.

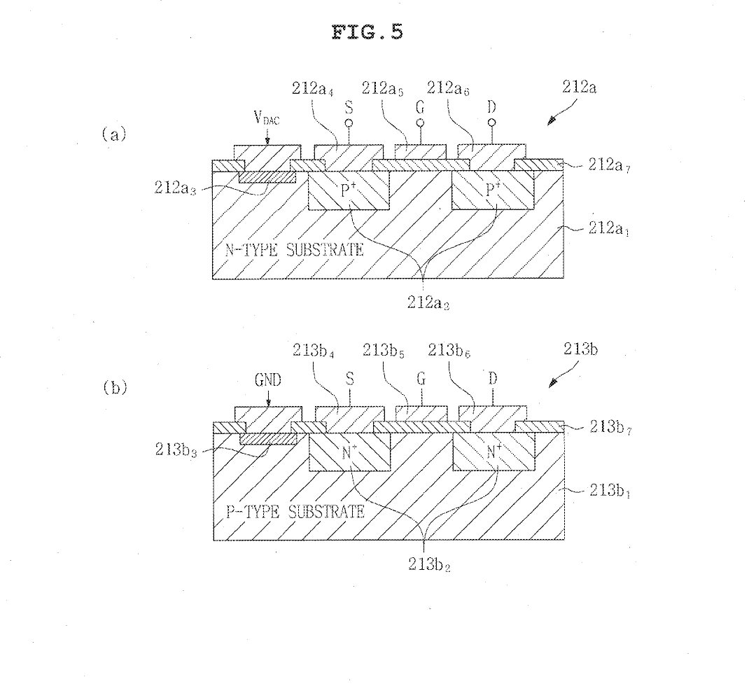

FIG. 3 is a circuit diagram illustrating an amplifier 200 of an offset correction system, in accordance with an embodiment of the present invention. FIG. 4 is a diagram illustrating an equivalent circuit diagram of the OP-AMP 210 of the amplifier 200, in accordance with an embodiment of the present invention. FIG. 5 is a diagram illustrating the structure of a PMOS and an NMOS included in the OP-AMP 210 of the amplifier 200, in accordance with an embodiment of the present invention.

As illustrated in FIG. 3, the amplifier 200, according to an embodiment of the invention, includes the OP-AMP 210 having an internal terminal to which an offset correction voltage for correction of DC offset generated between the first and second voltage signals V₁ and V₂ output from the hall sensor 110 is directly applied, first resistors R1 that are electrically connected to a non-inverting terminal V₊ and an inverting terminal V₋ of the OP-AMP 210, respectively, and a second resistor R2 that electrically connects the inverting terminal V₋ to an output terminal V_{O} of the OP-AMP 210, but is not limited to the circuit configuration. Thus, the amplifier 200 includes another circuit configuration for amplifying the first and second voltage signals V₁ and V₂ with predetermined gain.

As illustrated in FIG. 4, the OP-AMP 210 of the amplifier 200, in accordance with an embodiment of the invention, includes at least one PMOS and NMOS. In detail, the OP-AMP 210 includes a first PMOS 211 and a fourth PMOS 214 that control input current I_{D} and output current I_{P} using a bias voltage V_{bias} input to a gate terminal, an offset correction circuit 212 to which the offset correction voltage is applied, a current mirror circuit 213 for equalizing amounts of currents I_{D1} and I_{D2} output from the offset correction circuit 212, and a third NMOS 215 for amplifying the output current I_{P} with predetermined gain to generate the output terminal V_{O}. However, embodiments of the present invention are not limited thereto. Thus, the OP-AMP 210 includes another circuit configuration as long as equivalent objective is achieved.

In addition, the offset correction circuit 212, in accordance with an embodiment of the invention, includes a second PMOS 212a with a gate terminal that is electrically connected to the non-inverting terminal V₊ of the OP-AMP 210, and a third PMOS 212b with a gate terminal that is electrically connected to the inverting terminal V₋. An offset correction voltage for correction of DC offset generated between the output signals V₁ and V₂ of the hall sensor 110 is applied directly to a bulk terminal 212a₃ (refer to FIG. 5(a)) of a third PMOS 212b and the second PMOS 212a as an internal terminal of the OP-AMP 210.

In detail, as illustrated in FIG. 5(a), the second and third PMOSs 212a and 212b of the offset correction circuit 212 are configured in such a way that a P⁺ region 212a₂ (implanted with group 3 element (e.g., Indium (In), Boron (B), etc.)) is formed in an N-type substrate 212a, (implanted with group 5 element (e.g., arsenic (As), phosphorous (P), etc.), an insulating layer 212a₇ is formed on the N-type substrate 212a₁, a source terminal S 212a₄ and a drain terminal D 212a₆ are electrically connected to the P⁺ region 212a₂, and a gate terminal G 212a₅ is formed on the insulating layer 212a₇.

In addition, the bulk terminal 212a₃, according to an embodiment of the invention, is formed on the N-type substrate 212a₁, and an offset correction voltage for correction of DC offset generated between the outputs signals V₁ and V₂ of the hall sensor 110 is applied directly to the bulk terminal 212a₃.

Thus, as shown in FIG. 4 and Equations 1 and 2 below, when DC offset is generated between the outputs signals V₁ and V₂ of the hall sensor 110, the digital signal processor 400 generates a digital control signal for correction of the offset, converts the digital control signal into an offset correction voltage in an analog form via the second signal converter 800, and then applies the offset correction voltage to the bulk terminal 212a₃ of the second and third PMOSs 212a and 212b included in the offset correction circuit 212.

In detail, an amplitude of the offset correction voltage applied to the bulk terminal 212a₃ of the second and third PMOSs 212a and 212b is adjusted to control a voltage V_{SB} between the source terminal S 212a₄ and the bulk terminal 212a₃ to lower or enhance a threshold voltage V_{TH} of the second and third PMOSs 212a and 212b according to a body effect, as shown in Equation 1 below. Accordingly, as shown in Equation 2 below, amounts of drain currents I_{D1} and I_{D2} of the second and third PMOS 212a and 212b are controlled.

Furthermore, when the offset correction voltage varies according to the amount of DC offset generated between the output signals V₁ and V₂ of the hall sensor 110 and is applied to the bulk terminal 212a₃ of the second and third PMOSs 212a and 212b, drain currents I_{D1} and I_{D2} of the second and third PMOS 212a and 212b vary, the drain current I_{D2} and a voltage (a node N₂) formed by a second NMOS are applied to a gate terminal of the third NMOS 215, and the output current I_{P} and an output voltage V_{O} formed by the third NMOS 215 vary, thereby correcting the DC offset generated between the output signals V₁ and V₂ of the hall sensor 110 in real time.

As illustrated in FIG. 5(b), first to third NMOSs 215 of the offset correction circuit 212 are configured in such a way that a N⁺ region 213b₂ (implanted with group 5 element (e.g., arsenic (As), phosphorous (P), etc.)) is formed in a P-type substrate 213b₁ (implanted with group 3 element (e.g., Indium (In), Boron (B), etc.)), an insulating layer 213b₇ is formed on the P-type substrate 213b₁, a source terminal S 213b₄ and a drain terminal D 213b₆ are electrically connected to the N⁺ region 213b₂, and a gate terminal G 213b₅ is formed on insulating layer 213b₇. Here, a bulk terminal 213b₃ on the P-type substrate 213b₁ is electrically connected to a ground terminal GND.

V_{TH}=V_{T0}+γ(\sqrt{|φ_{S}|+|V_{SB}|}−\sqrt{φ_{S}}). [Equation 1]

(V_{TO}=substrate bias voltage, γ=body effect variable, Φ_{S}=surface voltage variable, and V_{SB}=voltage between source terminal and bulk terminal)

$${I}_{D} = \frac{β}{2} {( {V}_{GS} - {V}_{TH} )}^{2} \qquad [ Equation 2 ]$$

(ID=drain current and V_{GS}=voltage between gate terminal and source terminal)

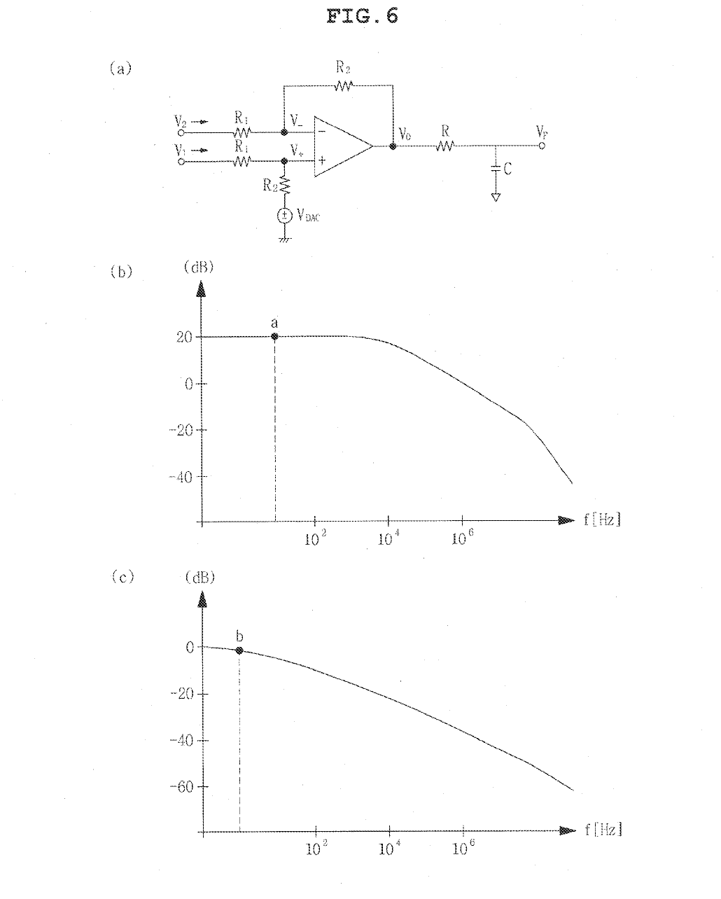

Hereinafter, correlation between an output voltage of an OP-AMP and noise generated in an offset correction voltage for correction of DC offset will be described in detail with reference to FIGS. 6(a)-(c).

FIG. 6(b) is a graph illustrating a frequency response curve between an offset correction voltage and an output voltage when an offset correction voltage is applied to a non-inverting terminal of an OP-AMP, in accordance with an embodiment of the present invention. FIG. 6(a) is a circuit diagram illustrating a case in which an offset correction voltage is applied to a non-inverting terminal of an OP-AMP, in accordance with an embodiment of the present invention. FIG. 6(c) is a graph illustrating a frequency response curve between an offset correction voltage and an output voltage when an offset correction voltage is applied to a bulk terminal of an OP-AMP, in accordance with an embodiment of the present invention.

As illustrated in FIG. 6(b), when an offset correction voltage is applied to the non-inverting terminal V₊ of the OP-AMP 210, |V_{O}/V_{DAC}| of a point a (f=42.79 Hz) is 19.8 (dB) and corresponds to about 9.8 times according to the frequency response curve between the offset correction voltage and the output voltage V_{O} of the OP-AMP. As illustrated in FIG. 6(a), in order to correct DC offset generated between the output signals V₁ and V₂ of the hall sensor 110, when the offset correction voltage is applied directly to the non-inverting terminal V₊ of the OP-AMP 210, if noise of 1 mV occurs in the offset correction voltage V_{DAC}, noise of 10 mV occurs in the output voltage V_{O}. Accordingly, in consideration of the real state in which an amplify gain of the amplifier 200 is set to about 200 times, a problem arises in that a significant amount of noise occurs in the output voltage V_{O} due to nose by the offset correction voltage.

However, like the offset correction system 10 of FIG. 6(c) according to an embodiment of the present invention, when an offset correction voltage is applied directly to the bulk terminal 212a₃ of the OP-AMP 210, |V_{O}/V_{DAC}| of a point b (f=42.79 Hz) is −5 (dB) and corresponds to about 0.5 times according to the frequency response curve between the offset correction voltage and the output voltage V_{O} of the OP-AMP 210. When noise of 1 mV occurs in the offset correction voltage V_{DAC}, noise of 0.5 mV occurs in the output voltage V_{O}. Accordingly, the amount of generated noise generated in the output voltage V_{O} is reduced to about 1/20 compared with a case in which the offset correction voltage is applied to the non-inverting terminal V⁺ of the OP-AMP 210.

As described above, an offset correction system according to an embodiment of the present invention applies the offset correction voltage directly to a bulk terminal of at least one PMOS included in an offset correction module, when DC offset occurs in an output signal of a hall sensor, and thus, minimizes influence of an output signal of the OP-AMP from noise generated in the offset correction voltage, thereby achieving more effective handshake correction and ensuring the stability of a system.

According to embodiments of the present invention, an offset correction system determines whether DC offset occurs in an output signal of a hall sensor, generates a digital control signal for correction of the DC offset when the DC offset occurs, and applies an offset correction voltage corresponding to the digital control signal directly to an internal terminal of an OP-AMP so as to correct the DC offset in real time, and thus, may more stably achieve high accuracy of handshake correction of an image due to handshake of a photographer when the lens is driven based on location information detected by a hall sensor.

In addition, the offset correction system applies the offset correction voltage to a bulk terminal of at least one PMOS included in an offset correction module when DC offset occurs in an output signal of a hall sensor, and thus, minimize influence of an output signal of an OP-AMP from noise generated in the offset correction voltage, thereby achieving more effective handshake correction and ensuring the stability of a system.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. An offset correction system, comprising:
a location sensor configured to output a signal about location information of a lens;
a digital signal processor configured to determine whether direct current (DC) offset occurs from the output signal and configured to generate a digital control signal for correction of the DC offset when the DC offset occurs; and
an amplifier configured to amplify the signal output by the location sensor via an operational amplifier (OP-AMP) and configured to apply an offset correction voltage corresponding to the digital control signal directly to an internal terminal of the OP-AMP when the DC offset occurs.

2. The offset correction system as set forth in claim 1, wherein the location sensor comprises a hall sensor configured to output a first voltage signal V1 and a second voltage signal V2, corresponding to a location of the lens.

3. The offset correction system as set forth in claim 1, wherein the OP-AMP comprises at least one P-channel metal oxide semiconductor (PMOS) and N-channel metal oxide semiconductor (NMOS).

4. The offset correction system as set forth in claim 3, wherein:
the internal terminal of the OP-AMP is a bulk terminal of the at least one PMOS, and
the PMOS has a gate terminal that is electrically connected to a non-inverting terminal or inverting terminal of the OP-AMP.

5. The offset correction system as set forth in claim 4, wherein the PMOS has a threshold voltage that varies according to the offset correction voltage input to the bulk terminal of the PMOS.

6. The offset correction system as set forth in claim 5, wherein the PMOS has drain current that varies according to the threshold voltage of the PMOS.

7. The offset correction system as set forth in claim 4, wherein the NMOS has a bulk terminal that is electrically connected to a ground terminal.

8. The offset correction system as set forth in claim 2, wherein the digital signal processor is configured to generate the digital control signal corresponding to the offset correction voltage for correction of the DC offset when the DC offset occurs between the first voltage signal V1 and the second voltage signal V2.

9. The offset correction system as set forth in claim 1, further comprising:
a second signal converter configured to convert the digital control signal into an offset correction voltage in an analog form and configured to apply the offset correction voltage to the amplifier.

10. The offset correction system as set forth in claim 1, further comprising:
a first signal converter configured to convert the signal output from the amplifier in a digital signal form.

11. The offset correction system as set forth in claim 1, wherein the amplifier comprises:
an OP-AMP having an internal terminal to which the offset correction voltage is directly applied,
a first resistor electrically connected to each of a non-inverting terminal and an inverting terminal of the OP-AMP, and
a second resistor configured to electrically connect the inverting terminal and an output terminal of the OP-AMP.

12. The offset correction system as set forth in claim 11, wherein the OP-AMP comprises a second PMOS having a gate terminal that is electrically connected to the inverting terminal and a third PMOS having a gate terminal that is electrically connected to the non-inverting terminal.

13. The offset correction system as set forth in claim 12, wherein the offset correction voltage is applied directly to a bulk terminal of the second PMOS and third PMOS.

14. The offset correction system as set forth in claim 1, wherein the OP-AMP comprises:
a first PMOS configured to control input current ID using a bias voltage input to a gate terminal,
an offset correction circuit to which the offset correction voltage is applied,
a current mirror module configured to equalize amounts of currents ID1 and ID2 output from the offset correction module,
a fourth PMOS configured to control output current IP using a bias voltage input to a gate terminal, and
a third NMOS configured to amplify the output current IP with predetermined gain to generate an output voltage VO.

15. The offset correction system as set forth in claim 14, wherein the offset correction circuit comprises a second PMOS having a gate terminal electrically connected to the inverting terminal of the OP-AMP and a third PMOS having a gate terminal electrically connected to the non-inverting terminal.

16. The offset correction system as set forth in claim 15, wherein the offset correction circuit is configured to apply the offset correction voltage directly to a bulk terminal of the second PMOS and third PMOS.

17. A method for controlling an offset correction system, the method comprising:
detecting a signal about location information of a lens;
amplifying the detected signal via an operational amplifier (OP-AMP);
determining whether direct current (DC) offset occurs from the detected signal; and
correcting offset by generating an offset correction voltage and applying the offset correction voltage to an internal terminal of the OP-AMP when the DC offset occurs.

18. The method as set forth in claim 17, wherein the correcting comprises:
generating a digital control signal for correction of the DC offset when the DC offset occurs,
converting the digital control signal into the offset correction voltage, corresponding to the digital control signal, in an analog form, and
applying the offset correction voltage to an internal terminal of the OP-AMP.

19. The method as set forth in claim 18, wherein:
the internal terminal of the OP-AMP is a bulk terminal of the at least one PMOS, and
the PMOS has a gate terminal that is electrically connected to a non-inverting terminal or inverting terminal of the OP-AMP.

20. The method as set forth in claim 17, further comprising:
converting the amplified signal in a digital signal form after the amplifying.
